(19) United States
(12) Patent Application Publication
(10) Pub. No.: US 2008/0020089 A1
(43) Pub. Date: Jan. 24, 2008

(54) Increased production of ethanol from corn and other biomass materials

(75) Inventor: Stanley R. Pearson, Baton Rouge, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(73) Assignee: Clean Energy, L.L.C.

(21) Appl. No.: 11/880,744

(22) Filed: Jul. 24, 2007

Related U.S. Application Data
(60) Provisional application No. 60/832,804, filed on Jul. 24, 2006.

(51) Int. Cl. C12C 11/06

(52) U.S. Cl. 426/14

(57) ABSTRACT

A process for substantially increasing the production of ethanol from corn and other such biomass feedstocks. Ethanol, carbon dioxide and distiller grains are typically produced during fermentation of corn starch. Both the carbon dioxide and the distiller grains are used as feedstocks for additional ethanol make in the practice of this invention.

### CROSS REFERENCE TO RELATED APPLICATIONS

This is based on Provisional Application 60/832,804 filed Jul. 24, 2006.

### FIELD OF THE INVENTION

The present invention relates to a process for substantially increasing the production of ethanol from corn and other such biomass feedstocks. Ethanol, carbon dioxide and distiller grains are typically produced during fermentation of corn starch. Both the carbon dioxide and the distiller grains are used as feedstocks for additional ethanol make in the practice of this invention.

### BACKGROUND OF THE INVENTION

As the world's petroleum supplies continue to diminish there is a growing need for feedstocks that can be substituted for various petroleum products, particularly transportation fuels. One such substitute is bioethanol that is derived from renewal biomass materials, such as sugar and corn. In a conventional ethanol production process utilizing corn as the starch containing feedstock, the corn is ground to produce a milled corn call meal. The milling can be either dry milling or wet milling. The meal is then mixed with water and and an enzyme, such as alpha-amylase, and then passed to cookers where the starch is liquefied. Heat is applied at this stage to enhance liquefaction. Cookers with a high temperature stage of about 120 to 150° C. and a lower temperature holding period of about 95° C. are used. The high temperatures reduce bacteria levels in the resulting mash.

The mash from the cookers is cooled and a secondary enzyme such as glucoamylase, is added to convert the liquefied starch to fermentable sugars (dextrose). Yeast is added to the mash to ferment the sugars to ethanol and carbon dioxide. Using a continuous process, the fermenting mash is allowed to flow through several fermenters until it is fully fermented. In a batch process, the mash stays in a single fermenter for about 48 hours before distillation. The fermented mash, now called beer, contains about 10% alcohol plus all the non-fermentable solids from the corn and yeast cells. The mash is pumped to a distillation system where the alcohol is removed from the solids and the water. The alcohol leaves the distillation system at about 95% strength, and the residue mash, called stillage, is transferred from the distillation system to a co-product processing area. The two main co-products in the production of ethanol from a biomass such as corn is carbon dioxide and distillers grains. Distillers grain, used wet or dry, is a highly nutritious livestock feed. The carbon dioxide is produced in relatively large quantities during fermentation and is either vented to the atmosphere or sold to other industries.

While commercial plants now exist for the production of ethanol from renewable sources, such as corn, they are not economical because of the large amounts of carbon dioxide and distillers grains that are produced and which are substantially lower in value than ethanol. Therefore, a need exists for improved processes from producing ethanol from biomass materials that can more economically utilize the large amounts of carbon dioxide and distillers grains produced in the process.

### SUMMARY OF THE INVENTION

In accordance with the present invention there is provided a process for converting corn to ethanol, which process comprising:

a) milling corn to produce a powdered meal;

b) adding an effective amount of water and a first enzyme to the meal to liquefy the corn starch and produce a mash;

c) cooking the mash for an effective amount of time at effective temperatures in the presence of a second enzyme;

d) adding an effective amount of yeast to said cooked mash and subjecting said cooked mash to fermentation;

e) distilling the fermented mash to produce ethanol, carbon dioxide, and distiller grains;

f) collecting the ethanol;

g) feeding at least a portion of the distiller grains and an effective amount of superheated steam into a reformer comprised of a plurality of coiled reactor tubes enclosed in a reformer vessel, which tubes are at a temperature of about 850° C. to about 1200° C. and pressures from about 3 psig to about 50 psig for an effective amount of time to produce a synthetic gaseous reaction product stream, which synthetic gaseous reaction product stream is at an elevated temperature;

h) passing said synthetic gaseous product stream at an elevated temperature to a heat recovery zone wherein its temperature is substantially lowered;

i) passing said lowered temperature synthetic gaseous product stream to a solids recovery zone wherein substantially all remaining solids are removed;

j) passing said synthetic gaseous product stream having a reduced amount of solids to an organics removal zone wherein substantially any remaining organic material is removed by contact with an organic liquid in which the organic material is at least partially soluble;

k) passing said synthetic gaseous product stream from said organics removal zone to an acid gas removal zone wherein acid gases are removed;

l) passing said synthetic gaseous product stream from said acid gas removal zone to a methanation process unit containing at least one methanation catalyst and operated at methanation process conditions thereby resulting in a product stream comprised predominantly of methane;

m) passing at least a portion of said methane from step l) above and at least a portion of the carbon dioxide produced in step e) above and an effective amount of super heated steam to a steam reformer in the presence of a nickel-containing catalyst and at a temperature from about 850° C. to 1,000° C. to produce a synthetic gaseous product comprised of hydrogen and carbon monoxide;

n) passing at least a portion of the synthetic gaseous product of step m) above to a Fischer-Tropsch reaction unit containing a suitable catalyst for the production of methanol and operated at reaction conditions, thereby producing a stream containing predominantly methanol;

o) passing at least of said methanol and a portion of the synthetic gaseous product of step m) above to a Fischer-Tropsch reaction unit containing a suitable catalyst for the production of ethanol and operated at reaction conditions, thereby producing a stream containing predominantly ethanol; and

p) collecting the ethanol produced in step s).

### BRIEF DESCRIPTION OF THE FIGURES

FIG. 1 hereof is a generalized flow scheme of a preferred embodiment of the present invention wherein corn is processed through a fermentation process to produce ethanol, carbon dioxide and distillers grains. The distillers grains are steam reformed to produce a syngas, which is then sent through various clean-up steps then to a methanation unit to produce synthetic natural gas. The synthetic natural gas is combined with at least a portion of the carbon dioxide and super heated water and steam reformed to produce a syngas that conducted to a Fischer-Tropsch process unit to produce an additional stream of ethanol.

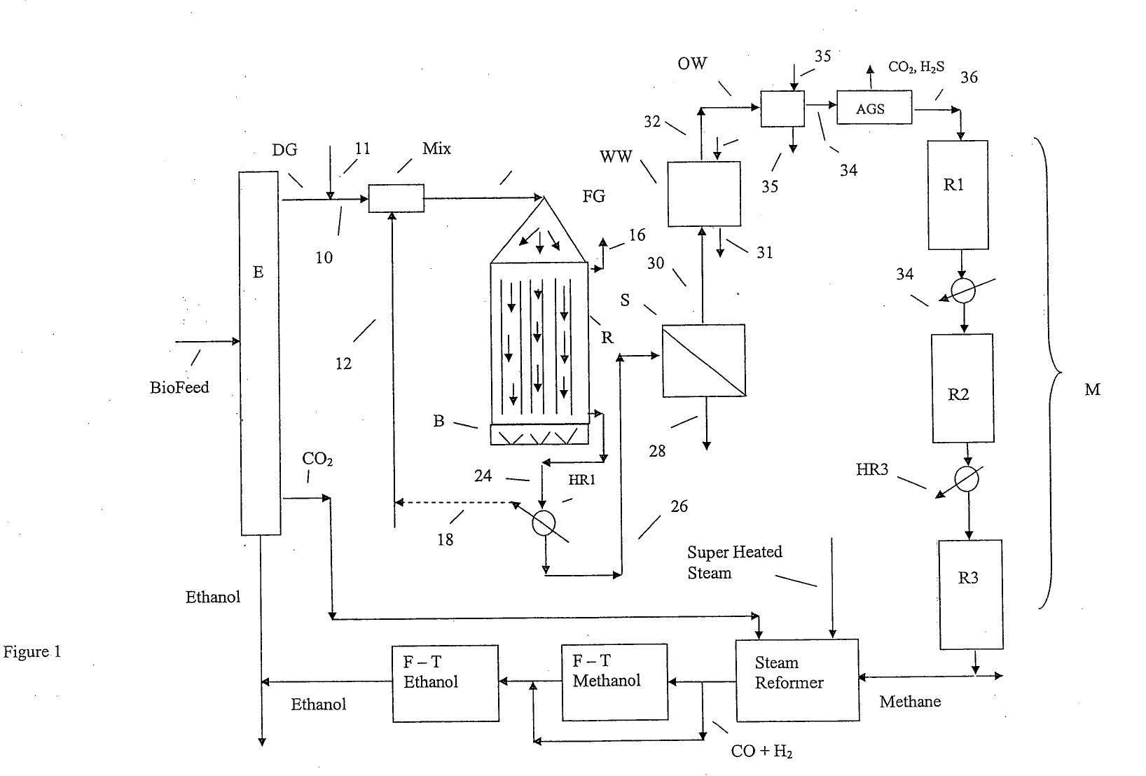

### DETAILED DESCRIPTION OF THE INVENTION

Any suitable biomass material can used in the practice of the present invention as long as it can produce ethanol, carbon dioxide and a solid biomass material, such as distillers grains. Preferred biomass materials include corn and sugar, preferably corn, including corn stover. Corn stover is the residue typically left in the field after harvest. Any suitable process can be used to produce ethanol from corn. In a typical conventional process utilizing corn as the starch containing feedstock, the corn is ground to produce a milled corn call meal. The milling can be either dry milling or wet milling. The meal is then mixed with water and and enzyme such as alpha-amylase and then passed through cookers where the starch is liquefied. Heat is applied at this stage to enable liquefaction. Cookers with a high temperature stage of about 120 to 150° C. and a lower temperature holding period of about 95° C. are used. The high temperatures reduce bacteria levels in the resulting mash.

The mash from the cookers is cooled and the secondary enzyme (glucoamylase) is added to convert the liquefied starch to fermentable sugars (dextrose). Yeast is added to the mash to ferment the sugars to ethanol and carbon dioxide. Using a continuous process, the fermenting mash is allowed to flow through several fermenters until it is fully fermented and leaves the final tank. In a batch process, the mash stays in one fermenter for about 48 hours before the distillation process is started. The feremented mash, now called beer, contains about 10% alcohol plus all the non-fermentable solids from the corn and yeast cells. The mash is pumped to the distillation system where the alcohol is removed from the solids and the water. The alcohol leaves the distillation system at about 95% strength, and the residue mash, called stillage, is transferred from the distillation system to a co-product processing area. The two main co-products in the production of ethanol is carbon dioxide and distillers grains. Distillers grain, used wet or dry, is a highly nutritious livestock feed. The carbon dioxide it produced in relatively large quantities during fermentation and is either vented to the atmosphere or sold to other industries.

Generally, the reformer requires that a feedstock have less than about 15% moisture content, but there is an optimization between moisture content and conversion process efficiency. The actual moisture content will vary somewhat depending on the commercial process equipment used. Since some of the biomass received for processing can have a moisture content from about 40 to 60% it will have to be dried before reforming. Any conventional drying technique can be used as long as the moisture content is lowered to less than about 15% when mixed with the superheated steam. For example, passive drying during summer storage can reduce the moisture content to about 30% or less. Active silo drying can reduce the moisture content down to about 12%. Drying can be accomplished either by very simple means, such as near ambient, solar drying or by waste heat flows or by specifically designed dryers operated on location. Also, commercial dryers are available in many forms and most common are rotary kilns and shallow fluidized bed dryers.

This invention can be better understood with reference to the sole figure hereof. The biomass feedstock, preferably corn, is fed to an ethanol processing plant E wherein an ethanol stream is produced, carbon dioxide is produced, and distiller grains. Such processing plants are well known in the art and thus there is no need to present a detailed technical discussion of these plants in this document. The ethanol is collected and the distillers grains, DG, which are preferably dried distiller grains, is a feedstock which is fed via line 10 and superheated steam is conducted via line 12 to mixing zone Mix wherein the two are sufficiently mixed before being conducted via line 14 into reformer process unit R. It will be understood the corn stover can also be used as a feedstock, via line 11 depending on the economics of the process. For example, the price of distillers grains typically varies since it can be used for animal feed and it's price will follow supply and demand. If the price is high, then one can substitute at least a portion of the distillers grains with stover. If the price of distillers grains is low then little if any stover will be substituted for distillers grains. The superheated steam, which will be at a temperature from about 315° C. to about 700° C. acts as both a source of hydrogen as well as a transport medium. The amount of superheated steam to feedstock will be an effective amount. By effective amount we mean at least that amount needed to provide sufficient transport of the feedstock. That ratio of superheated steam to feedstock, on a volume to volume basis, will typically be from about 0.2 to 2.5, preferably from about 0.3 to 1.0. The temperature conditions for the reforming reaction will be described later in detail. The steam is preferably introduced so that the feedstock is diluted to the point where it can easily be transported through the reactor tubes. Fluidization will typically result and can realize fluid reforming by virtue of good contact among steam, feed polymers and heat decomposition products of feedstock liberated in the gas phase.

The mixture of steam and feedstock, which will be at a temperature of above its dew point of greater than about 230° C., is fed to the reforming reactor R via line 14 into a flow divider FD where it is distributed into the plurality of coiled reactor tubes of effective internal diameter and length within a metal cylindrical vessel of suitable size. Flow divider FD can be any suitable design that will divide the feedstock substantially equally among the plurality of reactor tubes. The temperature of the mixture entering the pyrolysis unit will be at least about 230° C. Typical internal diameters for the reforming reactor tubes will be from about 2 to about 5 inches, preferably from about 2.5 to about 3.5 inches, and more preferably about 3 inches. The inlet temperature of the feedstock and superheated steam entering reformer R will preferably be about 200° C. The exit temperature of the product syngas leaving reformer R via line 24 will typically be from about 850° C. and 1200° C., preferably between about 900° C. and about 1000° C. At a temperature of about 1100° C. and above and with a contact time of about 1.5 seconds, one obtains less than about 5 mole percent of methane and about 15 mole percent of CO₂, which is an undesirable result. Pressure in the reformer is not critical, but it will typically be at about 3 to 50 psig. Also, it is preferred that the residence time in the reformer be from about 0.4 to about 1.5 seconds.

The source of heat for the reforming unit of the present invention, can be any suitable source, it is preferred that the source of heat be one or more burners B located at bottom of the reforming process unit. Fuel for the burners B can be any suitable fuel. It is preferred that at least a portion of the fuel to the burners be obtained from the present process itself, such as the syngas produced in the reformer. For example at least a portion of syngas stream can be diverted (not shown) and used as a fuel to burners B.

For any given feedstock, one can vary the proportions of hydrogen, carbon dioxide, carbon monoxide and methane that comprise the resulting syngas product stream as a function of the contact time of the pyrolysis oil feedstock in the reformer, the exit temperature, the amount of steam introduced, and to a lesser extent, pressure. Certain proportions of syngas components are better than others for producing synthetic natural gas, thus conditions should be such as to maximize the production of carbon monoxide and methane at the expense of hydrogen.

Returning now to the Figure hereof flue gas is exhausted from the reformer via line 16 and the product syngas stream from reformer R is conducted via line 24 to heat recovery zone HR1 where it is preferred that water be the heat exchange medium and that the water be passed as preheated steam to reformer R via line 18 where it is further heated to produce at least a portion of the superheated steam. Heat Recovery zone HR1 can be any suitable heat exchange device, such as the shell-and-tube type wherein water is used to remove heat from product stream 24. From heat recovery zone HR1 the product syngas is passed via line 26 through separation zone S which contains a gas filtering means and preferably a cyclone (not shown) and optionally a bag house (not shown) to remove at least a portion, preferably substantially all, of the remaining ash and other solid fines from the syngas. The filtered solids are collected via line 28 for disposal.

The filtered syngas stream is then passed via line 30 to water wash zone WW wherein it is conducted upward and countercurrent to down-flowing water via line 31. The water wash zone preferably comprises a column packed with conventional packing material, such as copper tubing, pall rings, metal mesh or other such materials. The syngas passes upward countercurrent to down-flowing water which serves to further cool the syngas stream to about ambient temperature, and to remove any remaining ash that may not have been removed in separation zone S. The water washed syngas stream is then passed via line 32 to oil wash zone OW where it is passed countercurrent to a down-flowing organic liquid stream to remove any organics present, such as benzene, toluene, xylene, or heavier hydrocarbon components via line 35 that may have been produced in the reformer. The down-flowing organic stream will be any organic stream in which the organic material being removed is substantially soluble. It is preferred that the down-flowing organic stream be a hydrocarbon stream, more preferably a petroleum fraction. The preferred petroleum fractions are those boiling in naphtha to distillate boiling range, more preferably a C₁₆ to C₂₀ hydrocarbon stream, most preferably a C₁₈ hydrocarbon stream.

The resulting syngas stream is conducted via line 34 to acid gas scrubbing zone AGS wherein acidic gases, preferably CO₂ and H₂S are removed. Any suitable acid gas treating technology can be used in the practice of the present invention. Also, any suitable scrubbing agent, preferably a basic solution can be used in the acid gas scrubbing zone AGS that will adsorb the desired level of acid gases from the vapor stream. It will be understood that it may be desirable to leave a certain amount of CO₂ in the scrubbed stream depending on the intended use of resulting methane product stream from the methanation unit. For example, if the methane product stream is to be introduced into a natural gas pipeline, no more than about 4 vol. % of CO₂ should be remain. If the methane product stream is to be used for the production of methanol, then at least that stoichiometric amount of CO₂ needed to result in the production of methanol should remaing. One suitable acid gas scrubbing technology is the use of an amine scrubber. Non-limiting examples of such basic solutions are the amines, preferably diethanol amine, mono-ethanol amine, and the like. More preferred is diethanol amine. Another preferred acid gas scrubbing technology is the so-called “Rectisol Wash” which uses an organic solvent, typically methanol, at subzero temperatures. The scrubbed stream can also be passed through one or more guard beds (not shown) to remove catalyst poisoning impurities such as sulfur, halides etc. The treated stream is passed via line 36 from acid gas scrubbing zone AGS to methanation zone M. Methanation of syngas involves a reaction between carbon oxides, i.e. carbon monoxide and carbon dioxide, and hydrogen in the syngas to produce methane and water, as follows:

CO+3H₂ CH₄+H₂O (1)

CO₂+4H₂ CH₄+2H₂O (2)

Methanation reactions (1) and (2) take place at temperatures of about 300° C. to about 900° C. in methanation zone M which is preferably comprised of two or more, more preferably three, reactors each containing a suitable methanation catalyst. The methanation reaction is strongly exothermic. Generally, the temperature increase in a typical methanator gas composition is about 74° C. for each 1% of carbon monoxide converted and 60° C. for each 1% carbon dioxide converted. Because of the exothermic nature of methanation reactions (1) and (2), the temperature in the methanation reactor during methanation of syngas has to be controlled to prevent overheating of the reactor catalyst. Also high temperatures are undesirable from an equilibrium standpoint and reduce the amount of conversion of syngas to methane since methane formation is favored at lower temperatures. Formation of soot on the catalyst is also a concern and may require the addition of water to the syngas feedstock.

A preferred way to control heat during the methanation reaction is use a plurality of reactors with heat removed between each reactor. Thus, methanation zone M preferably comprises a series of three adiabatic methanation reactors R1, R2 and R3. Each of these reactors is configured to react carbon oxide and hydrogen contained in the syngas in the presence of a suitable catalyst to produce methane and water, in accordance with the reactions (1) and (2) set forth hereinabove. Each of the methanation reactors includes a catalyst capable of promoting methanation reactions between carbon oxides and hydrogen in the syngas feedstock. Any conventional methanation catalyst is suitable for use in the practice of the present invention, although nickel catalysts are most commonly used and the more preferred for this invention. Such catalysts are, especially those containing greater than 50% nickel, are generally stable against thermal and chemical sintering during methanation of undiluted syngas streams. Alternatively, other stable catalysts that are active and selective towards methane may be used in the methanation reactors.

As previously mentioned because the methanation reaction is strongly exothermic, heat needs to be removed between reactors. Thus, heat recover zones HR2 and HR3 are used to remove heat from the stream as it passed from reactor R1 to reactor R2 and reactor R2 to reactor R3 respectively. Any suitable exchange device can be used, preferably a shell-and-tube type wherein water can be used to remove heat from the product stream. The water can then be recycled to one or both of 12 and 23 where it can be further heated to produce superheated steam. As can be appreciated from the above and as shown in the examples discussed below, the inlet and outlet temperatures of the streams entering and exiting methanation reactors R1-R3 can be controlled by varying the percentage of syngas being delivered to each of the reactors as well as how much heat is exchanged by heat exchangers HR2 and HR3. Typically, the inlet temperature of reactors R1 and R2 will be from about 400° F. to about 450° F. with an outlet temperature of about 500° F. to about 800° F. The third reactor, which will operate at a lower temperature than that of reactors R1 and R2 will have an inlet temperature of about 400° F. and an outlet temperature of about 500° F.

In a preferred embodiment of the present invention, the step of recovering at least a part of generated heat and/or at least a part of waste heat in the regeneration zone and effectively utilizing the recovered heat is further provided. The recovered heat can be effectively utilized, for example, for drying and heating of the biomass feedstock and the generation of steam as the gasifying agent.

The product stream from the methanation unit will be comprised predominantly of methane. That is, it will contain at least about 75 vol. %, preferably at least about 85 vol. %, and more preferably at least about 95 vol. % methane. If the methane product stream is to be introduced into a natural gas pipeline, then it must meet the specification requirements for the pipeline. Such a specification for most pipelines, with respect to CO₂ content will be less than about 4 volume percent. If the methane product stream is to be used for the production of methanol, then higher amounts of CO₂ will be required. The product methane stream is preferably introduced into a natural gas pipeline and utilized at any downstream facility. One such facility if preferably a plant that converts the methane to syngas then to other products, such as alcohols, transportation fuels, or lubricant base stocks. If it is desired to produce syngas from the methane produced in the methanation unit M, then any suitable process can be used that convert methane or natural gas to syngas. Preferred methods include steam reforming and partial oxidation. More preferred is steam reforming. Steam reforming of methane is a highly endothermic process and involves following reactions:

Main Reaction

CH₄+H₂O CO+3H₂ −54.2 Kcal per mole of CH₄ at about 800° C. to about 900° C.

Side Reaction

CO+H₂O CO₂+H₂ +8.0 kcal per mole of CO at about 800° C. to about 900° C.

CO₂ reforming of methane: It is also a highly endothermic process and involves the following reactions:

Main Reaction

CH₄+CO 2CO+2H₂ −62.2 kcal per mole of CH₄ at about 800° C. to about 900° C.

Side Reaction: Reverse Water Gas Shift Reaction

CO₂+H₂ CO+H₂O −8.0 kcal per mole of CO₂ at about 800° C. to about 900° C.

The steam reformer will preferably be one similar to reformer R hereof, which is a coiled tubular reactor. Preferred steam reforming catalysts are nickel containing catalysts, particularly nickel (with or without other elements) supported on alumina or other refractory materials, in the above catalytic processes for conversion of methane (or natural gas) to syngas is also well known in the prior art. Kirk and Othmer, Encyclopedia of Chemical Technology, 3rd Ed., 1990, vol. 12, p. 951; Ullmann's Encyclopedia of Industrial Chemistry, 5th Ed., 1989, vol. A12, pp. 186 and 202; U.S. Pat. No. 2,942,958 (1960); U.S. Pat. No. 4,877,550 (1989); U.S. Pat. No. 4,888,131 (1989); EP 0 084 273 A2 (1983); EP 0 303 438 A2 (1989); and Dissanayske et al., Journal of Catalysis, vol. 132, p. 117 (1991).

The catalytic steam reforming of methane, or natural gas, to syngas is a well established technology practiced for commercial production of hydrogen, carbon monoxide and syngas (i.e., a mixture of hydrogen and carbon monoxide). In this second steam reforming process of the present invention the product synthetic gaseous product will be predominantly H₂ and CO due to CO₂ being part of the feed into the reformer. The reformer reaction will be over a suitable supported steam reforming catalyst, preferably a nickel catalyst such as NiO supported on alumina at elevated temperature (850° C. to 1000° C.) and pressure (10-40 atm) and at steam to carbon mole ratio of 2-5 and gas hourly space velocity of about 5000-8000 per hour.

This process is highly endothermic and hence it is carried out in a number of parallel tubes packed with a catalyst and externally heated by flue gas to a temperature of 980° C. to about 1040° C. (Kirk and Othmer, Encyclopedia of chemical Technology, 3rd, Ed., 1990, vol. 12, p. 951, Ullmann's Encyclopedia of Industrial Chemistry, 5th Ed., 1989, vol. A12, p. 186).

The synthetic gaseous product comprised predominantly of CO and H₂ and a side stream of an effective amount of CO₂ from the fermentation process is conducted to a methanol Fischer-Tropsch reactor which is catalyzed to favor the production of methanol. The catalyst used will be a conventional methanol catalyst, primarily a copper catalyst with minor amounts of an alkali metal promoter. The catalyst will typically be comprised of copper oxide, zince oxide, aluminum oxide and an alkali metal promoter. Copper oxide comprises about 55 wt. %, zinc oxide about 21 to 25 wt. %, aluminum oxide about 8 to about 10 wt. %, with the remainder being tramp amounts of other ingredients.

The methanol reactor is operated under a pressure from about 650 to about 2,000 psig and at temperatures from about 260° to about 305° C. The gas hourly space velocity will be from about 15,000 per hour to about 110,000 per hour. It is preferred that all feed lines to the methanol reactor will be at operating pressures and each will contain a check valve. The feed to the methanol reactor is heated to a temperature above the dew point. The principle methanol reaction between carbon dioxide and hydrogen will be:

3H₂+CO₂ CH₃OH+H₂O

At least a portion of the methanol along with a portion of the CO+H₂ from the secondary steam reformer is passed to the Fischer-Tropsch ethanol reactor. It is preferred that the ratio of CO to H₂ be about 1 to 1. It is preferred that the ethanol reactor be comprised of a series of stainless steel reactor tubes, each of suitable diameter, for example from about 1 to 2 inches in diameter. The reactor tubes are loaded with a suitable catalyst that favors the production of ethanol. Larger diameter reactor tubes give higher production capacity, but also allow for the generation of more heat, that is deleterious to the catalyst. Thus, the tube diameter will usually be selected as a compromise between flow through capacity desired and the ease with which the heat can be controlled.

The production of ethanol generates considerably more heat than does the production of methanol. Therefore, one has to remove about 2.6 times as much heat from an ethanol catalyzed Fischer-Tropsch reactor as from a Fischer-Tropsch reactor catalyzed to produce methanol. The threshold temperature for ethanol production is about 260° C. The ethanol reactor operates at a temperature from about 300° C. to about 500° C., and a pressure from about 650 to about 2,000 psig. The gas hourly space velocity in the ethanol reactor is from about 8,000 to about 50,000 per hour.

Any conventional ethanol producing catalyst can be used in the Fischer-Tropsch reactor of the present invention. Preferred catalysts are those that are based on cobalt with minor amounts of other elements selected from the group consisting of manganese, zinc, chromium and/or aluminum, and an alkali or alkaline earth metal promoter, with potassium carbonate being preferred for economic reasons. The more preferred ethanol catalysts will be comprised of about 65 wt. % to about 75 wt. % cobalt, about 4 wt. % to about 12 wt. % manganese, about 4 wt. % to about 10 wt. % zinc, about 6 wt. % to about 10 wt. % chromium, and/or about 6 wt. % to about 10 wt. % aluminum, wherein all weight percents are based only on the metal content without binder or carrier.

While the catalyst as used consists primarily of the above elements in their elemental form, the catalysts are typically prepared from a mixture of metal salts. Nitrates and carbonates are preferred. The catalysts used in the both the methanol reactor and the ethanol reactor of this invention will be subjected to a “conditioning” process wherein the salts are largely reduced to their metallic state, with some oxides remaining to form a lattice structure referred to as spinels. The spinel structure help give the catalysts their overall special structure. The catalysts may be used in their pure (or concentrated) form, or they may be diluted with carbon, by loading onto carbon pellets. The later is often referred to as supported catalyst. A “pure” catalyst will tend to run hotter than a supported catalyst. On the other hand a “pure” catalyst will be more active and hence can be used at lower reaction temperatures. Thus a compromise must often be reached between the desirability of using a more reactive catalyst and the need to dilute it in order to facilitate temperature control.

The reaction products from the ethanol reactor are sent to a distillation tower wherein ethanol is separated from other products, such as methanol, which can be recycled to the ethanol reactor. The predominant reaction product will be ethanol, which when added to the ethanol product of fermentation substantially increases the yield of ethanol from a given amount of corn.

What is claimed is:

1. A process for converting corn to ethanol, which process comprising:
a) milling corn to produce a powdered meal;
b) adding an effective amount of water and a first enzyme to the meal to liquefy the corn starch and produce a mash;
c) cooking the mash for an effective amount of time at effective temperatures in the presence of a second enzyme;
d) adding an effective amount of yeast to said cooked mash and subjecting said cooked mash to fermentation;
e) distilling the fermented mash to produce ethanol, carbon dioxide, and distiller grains;
f) collecting the ethanol;
g) feeding at least a portion of the distiller grains and an effective amount of superheated steam into a reformer comprised of a plurality of coiled reactor tubes enclosed in a reformer vessel, which tubes are at a temperature of about 850° C. to about 1200° C. and pressures from about 3 psig to about 50 psig for an effective amount of time to produce a synthetic gaseous reaction product stream, which synthetic gaseous reaction product stream is at an elevated temperature;
h) passing said synthetic gaseous product stream at an elevated temperature to a heat recovery zone wherein its temperature is substantially lowered;
i) passing said lowered temperature synthetic gaseous product stream to a solids recovery zone wherein substantially all remaining solids are removed;
j) passing said synthetic gaseous product stream having a reduced amount of solids to an organics removal zone wherein substantially any remaining organic material is removed by contact with an organic liquid in which the organic material is at least partially soluble;
k) passing said synthetic gaseous product stream from said organics removal zone to an acid gas removal zone wherein acid gases are removed;
l) passing said synthetic gaseous product stream from said acid gas removal zone to a methanation process unit containing at least one methanation catalyst and operated at methanation process conditions thereby resulting in a product stream comprised predominantly of methane;
m) passing at least a portion of said methane from step l) above and at least a portion of the carbon dioxide produced in step e) above and an effective amount of super heated steam to a steam reformer in the presence of a nickel-containing catalyst and at a temperature from about 850° C. to 1,000° C. to produce a synthetic gaseous product comprised of hydrogen and carbon monoxide;
n) passing at least a portion of the synthetic gaseous product of step m) above to a Fischer-Tropsch reaction unit containing a suitable catalyst for the production of methanol and operated at reaction conditions, thereby producing a stream containing predominantly methanol;
o) passing at least of said methanol and a portion of the synthetic gaseous product of step m) above to a Fischer-Tropsch reaction unit containing a suitable catalyst for the production of ethanol and operated at reaction conditions, thereby producing a stream containing predominantly ethanol; and
p) collecting the ethanol produced in step o).
